(19) United States
(12) Patent Application Publication
(10) Pub. No.: US 2017/0201396 A1
(43) Pub. Date: Jul. 13, 2017

(54) Systems and Methods for Back Channel Adaptation Coefficient Modification

(71) Applicant: Avago Technologies General IP (Singapore) Pte. Ltd, Singapore (SG)

(72) Inventors: Mohammad Mobin, Orefield, PA (US); Haitao Xia, San Jose, CA (US); Nayak Ratnakar Aravind, Allentown, PA (US)

(21) Appl. No.: 14/993,148

(22) Filed: Jan. 12, 2016

(51) Int. Cl. H04L 25/03

(52) U.S. Cl. CPC H04L 25/03891; H04L 2025/03433

(57) ABSTRACT

Embodiments are related to systems and methods for data processing, and more particularly to systems and methods for back channel control in a serial data transfer.

### FIELD OF THE INVENTION

Embodiments are related to systems and methods for data processing, and more particularly to systems and methods for back channel control in a serial data transfer.

### BACKGROUND

A number of data transfer systems have been developed. Some transfer systems transfer information in serial. To increase data transfer rates the period between bit periods is decreased. While such reduction in period results in increased transfer rates, it can lead to increased error rates. These error rates are most evident where the transfer data is not properly controlled.

Hence, for at least the aforementioned reasons, there exists a need in the art for advanced systems and methods for enhancing control of transfer data.

### SUMMARY

Embodiments are related to systems and methods for data processing, and more particularly to systems and methods for back channel control in a serial data transfer.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Many other embodiments of the invention will become more fully apparent from the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a shows a serial data transfer system including a serial data transmission circuit having BCA controlled equalizer circuitry and a serial data receiver circuit including margining enabled BCA coefficient modification circuitry in accordance with various embodiments of the present inventions;

FIG. 1b shows a finite impulse response filter circuit included as part of the BCA controlled equalizer circuitry of the serial data transmission circuit of FIG. 1a that may be used in relation to various embodiments of the present inventions;

FIG. 2a graphically depicts an example serial data signal eye bounded by a margin controlled window that may be sampled using systems and/or methods in accordance with different embodiments of the present inventions;

FIG. 2b graphically depicts the margin controlled window of FIG. 2a in relation to an overall capability window;

FIG. 3a depicts a coefficient calculation circuit that may be used as part of the margining enabled BCA coefficient modification circuitry of the serial data receiver circuit of FIG. 1a in accordance with some embodiments of the present inventions;

FIG. 3b graphically depicts a data window used to calculate a pre-cursor adaptation coefficient (CM1) by the coefficient calculation circuit of FIG. 3a in accordance with one or more embodiments of the present inventions; and

FIG. 3c graphically depicts a data window used to calculate a post-cursor adaptation coefficient (CP1) by the coefficient calculation circuit of FIG. 3a in accordance with one or more embodiments of the present inventions; and

FIG. 4 depicts a group delay coefficient calculation circuit that may be used as part of the margining enabled BCA coefficient modification circuitry of the serial data receiver circuit of FIG. 1a in accordance with some embodiments of the present inventions.

### DETAILED DESCRIPTION OF SOME EMBODIMENTS

Embodiments are related to systems and methods for data processing, and more particularly to systems and methods for back channel control in a serial data transfer.

Various embodiments of the present invention provide serial data processing systems that include a data receiving circuit having a coefficient calculation circuit. The data receiving circuit is operable to receive a serial data input, and the coefficient calculation circuit: calculates a gradient output based at least in part upon a first instance of the serial data input, a second instance of the serial data input, and a third instance of the serial data input; determines a first disable condition for the first instance of the serial data input, a second disable condition for the second instance of the serial data input, and a third disable condition for the third instance of the serial data input; and includes the first instance of the serial data input in the calculation of the gradient output based upon the first disable condition, and includes the second instance of the serial data input in the calculation of the gradient output based upon the second disable condition, and excludes the third instance of the serial data input in the calculation of the gradient output based upon the third disable condition. In some cases, the data receiving circuit is implemented as part of an integrated circuit. In various cases, the serial data processing system is implemented as part of a storage device.

In some instances of the aforementioned embodiments, the third disable condition is may be one of: an absolute value of a voltage level of an XXY transition corresponding to the third instance of the serial data input being less than an absolute value of a voltage level of an XYX transition, an absolute value of the voltage level of the XXY transition corresponding to the third instance of the serial data input being less than a first threshold, or an absolute value of the voltage level of the XXY transition corresponding to the third instance of the serial data input being greater than a second threshold.

In various instances of the aforementioned embodiments, the systems further include: a first accumulator circuit operable to add the gradient output to previous instance of an accumulated gradient output to yield a subsequent instance of the accumulated gradient output; and a second accumulator circuit operable to add an accumulator input derived from the subsequent instance of the accumulated gradient output to a previous instance of a sum to yield a subsequent instance of the sum. In some such instances, the systems further include a comparator circuit operable to compare the subsequent instance of the sum with an upper limit and a lower limit to yield a coefficient modification output. The coefficient modification output is set equal to: a first value when the subsequent instance of the sum is greater than the upper threshold, a second value when the subsequent instance of the sum is between the upper threshold and the lower threshold, or a third value when the subsequent instance of the sum is less than the lower threshold. In some cases, at least one of the upper threshold or the lower threshold is programmable. In one or more instances, the systems include a multiplication circuit operable to multiply the subsequent instance of the accumulated gradient output by a gain to yield the accumulator input. In some such instances, the gain is programmable.

In various instances of the aforementioned embodiments, the systems include a serial data transmission circuit having a filter circuit. The filter circuit is operable to apply a filtering algorithm to a transfer data set to yield an output data set, the serial data input is derived from the output data set, operation of the filter circuit is governed at least in part based upon a coefficient modification output received from the data receiving circuit, and the coefficient modification output corresponds to the gradient output.

Other embodiments provide data processing systems that include a data receiving circuit having a coefficient determination circuit. The data receiving circuit is operable to receive a serial data input, and the coefficient determination circuit is operable to: set a gradient output equal to a first value when a series of a preceding number of instances of the serial data input are equal to an x value, an instance of the serial data corresponding to a transition between the x value and a y value is equal to the x value, and a series of a succeeding number of instances of the serial data input are equal to the y value; or set the gradient output equal to a second value when the series of the preceding number of instances of the serial data input are equal to the x value, the instance of the serial data corresponding to the transition between the x value and the y value is equal to the y value, and the series of the succeeding number of instances of the serial data input are equal to the y value. The x value is a first binary state and the y value is a second binary state opposite the first binary state.

Other embodiments provide methods for serial data processing. The methods include: receiving a serial data input at a serial data receiver circuit, where the serial data input is received from a serial data transmission circuit; calculating a gradient output based at least in part upon a first instance of the serial data input, a second instance of the serial data input, and a third instance of the serial data input; determining a first disable condition for the first instance of the serial data input, a second disable condition for the second instance of the serial data input, and a third disable condition for the third instance of the serial data input; including the first instance of the serial data input in the calculation of the gradient output based upon the first disable condition; including the second instance of the serial data input in the calculation of the gradient output based upon the second disable condition; excluding the third instance of the serial data input in the calculation of the gradient output based upon the third disable condition, where the third disable condition is one of: an absolute value of a voltage level of an XXY transition corresponding to the third instance of the serial data input being less than an absolute value of a voltage level of an XYX transition, an absolute value of the voltage level of the XXY transition corresponding to the third instance of the serial data input being less than a first threshold, or an absolute value of the voltage level of the XXY transition corresponding to the third instance of the serial data input being greater than a second threshold; generating a coefficient modification value corresponding to the gradient output; transferring the coefficient modification value to the serial data transmission circuit via a medium; and generating the serial data input in the serial data transmission circuit using the coefficient modification value.

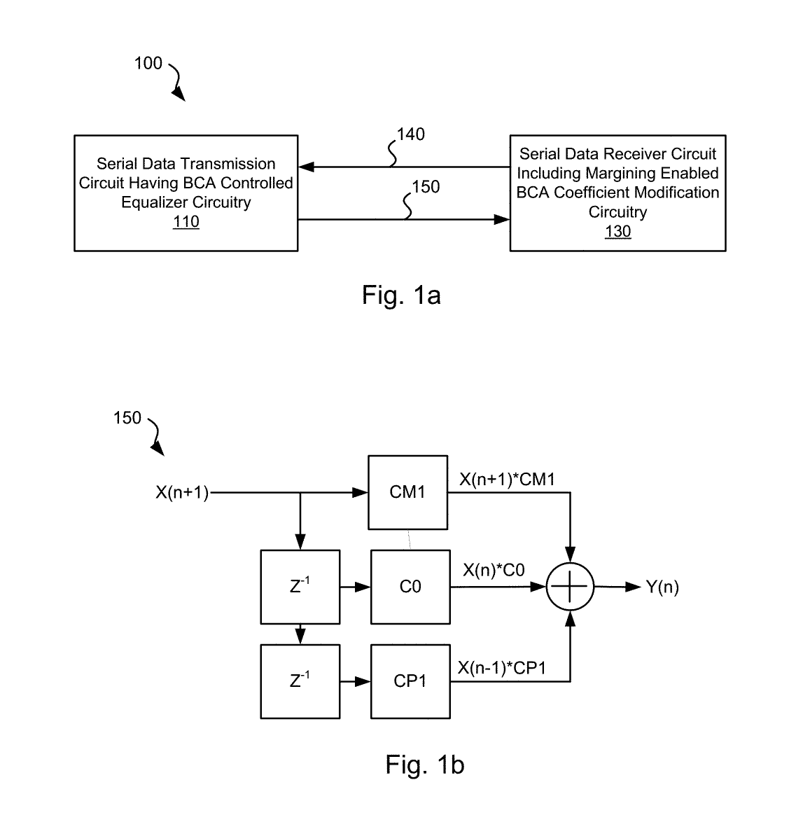

Turning to FIG. 1, a serial data transfer system 100 is shown that includes a serial data transmission circuit 110 and a serial data receiver circuit 130. Serial data transmission circuit 110 may be any circuit known in the art for generating a stream of serial data to be transferred to serial data receiver circuit 130 as a serial output 150. Based upon the disclosure provided herein, one of ordinary skill in the art will recognize a variety of data transmission circuitry that may be used in relation to different embodiments of the present invention. Serial output 150 is equalized using Back Channel Adapted (BCA) controlled equalizer circuitry. In some embodiments, the BCA equalizer circuitry includes a finite impulse response filter circuit with its operation governed at least in part based upon one or more filter coefficients received as a back channel input 140 from serial data receiver circuit 130.

Turning to FIG. 1b, an example finite impulse response filter circuit 150 is shown that may be included as part of the BCA controlled equalizer circuitry of serial data transmission circuit 110. As shown, finite impulse response filter circuit 150 equalizes a data input (X) to yield an equalized output (Y). The equalized output is provided as serial output 150. In particular, three successive instances of the data input (i.e., X(n−1), X(n), and X(n+1)) are filtered by respective coefficients (i.e., a pre-cursor coefficient (CM1), a main-cursor coefficient (C0), and a post-cursor coefficient (CP1). The results of the filtering (i.e., X(n−1)*CM1, X(n)*C0, and X(n+1)*CP1) are summed to yield the equalized output. In some embodiments, the pre-cursor coefficient (CM1) and the post-cursor coefficient (CP1) are received as back channel input 140, and the main-cursor (C0) is adapted local to serial data transmission circuit 110. Based upon the disclosure provided herein, one of ordinary skill in the art will recognize a variety of coefficients that may be received as part of back channel input 140.

The medium over which back channel input 140 and serial output 150 are transferred may be, but is not limited to, a wired or wireless transfer medium. Such wired transfer mediums may be a metal wire transfer medium capable of transmitting electrical signal, or may be an optical transfer medium capable of transferring light. Based upon the disclosure provided herein, one of ordinary skill in the art will recognize a variety of wired transfer media that may be used in relation to different embodiments of the present invention. The aforementioned wireless transfer mediums may be an atmosphere capable of transmitting, for example, radio frequency signals. Based upon the disclosure provided herein, one of ordinary skill in the art will recognize a variety of wireless transfer media that may be used in relation to different embodiments of the present invention.

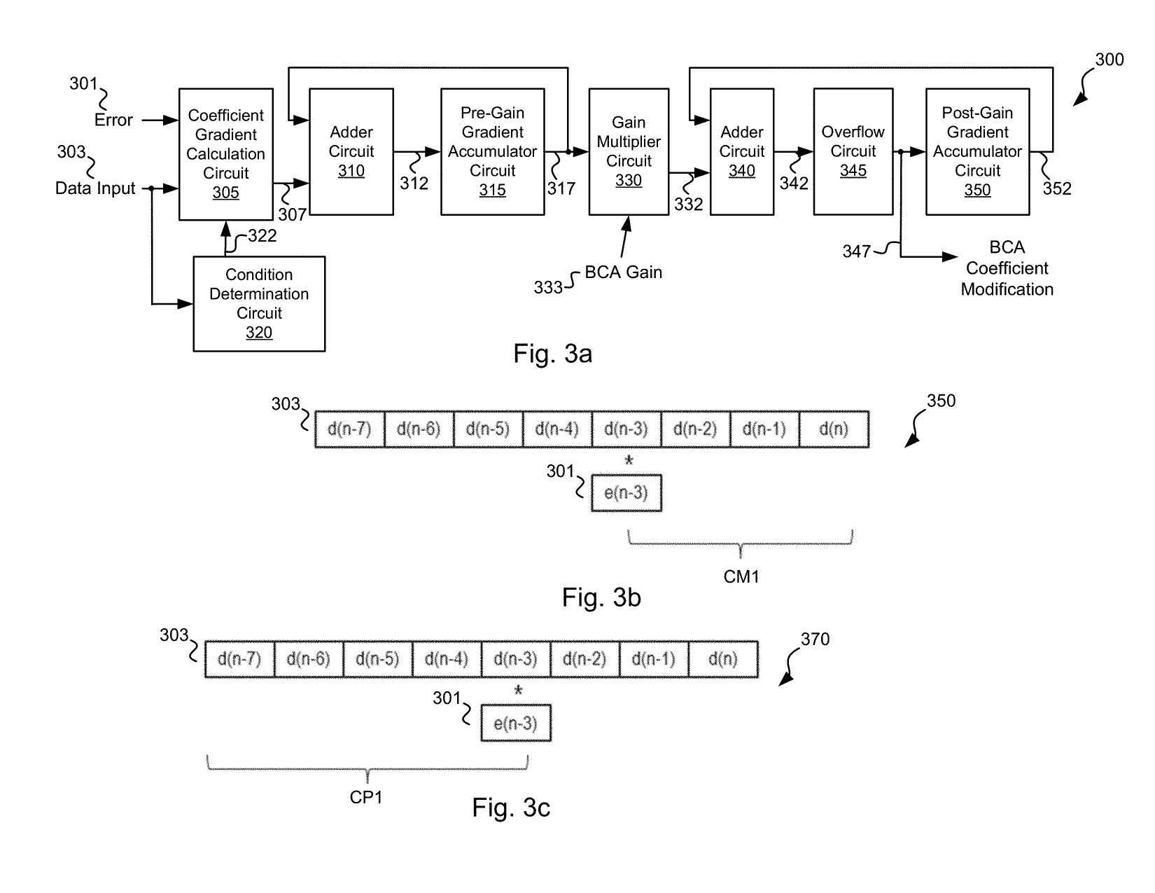

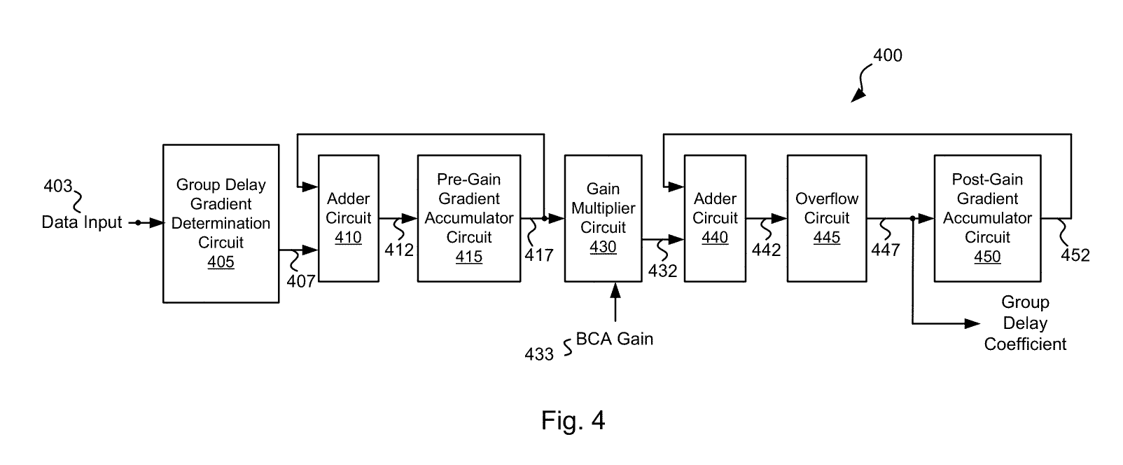

Serial data receiver circuit 130 receives the serial data 150 where it is sampled and processed. Serial data receiver circuit includes margining enabled BCA coefficient modification circuitry that calculates coefficients for use by the BCA controlled equalizer circuitry included as part of serial data transmission circuit 110. FIG. 3a shows one implementation of a coefficient calculation circuit included as part of the BCA controlled equalizer circuitry. FIG. 4 shows another implementation of a coefficient calculation circuit included as part of the BCA controlled equalizer circuitry. The resulting coefficients are transferred back to serial data transmission circuit 110 as back channel input 140.

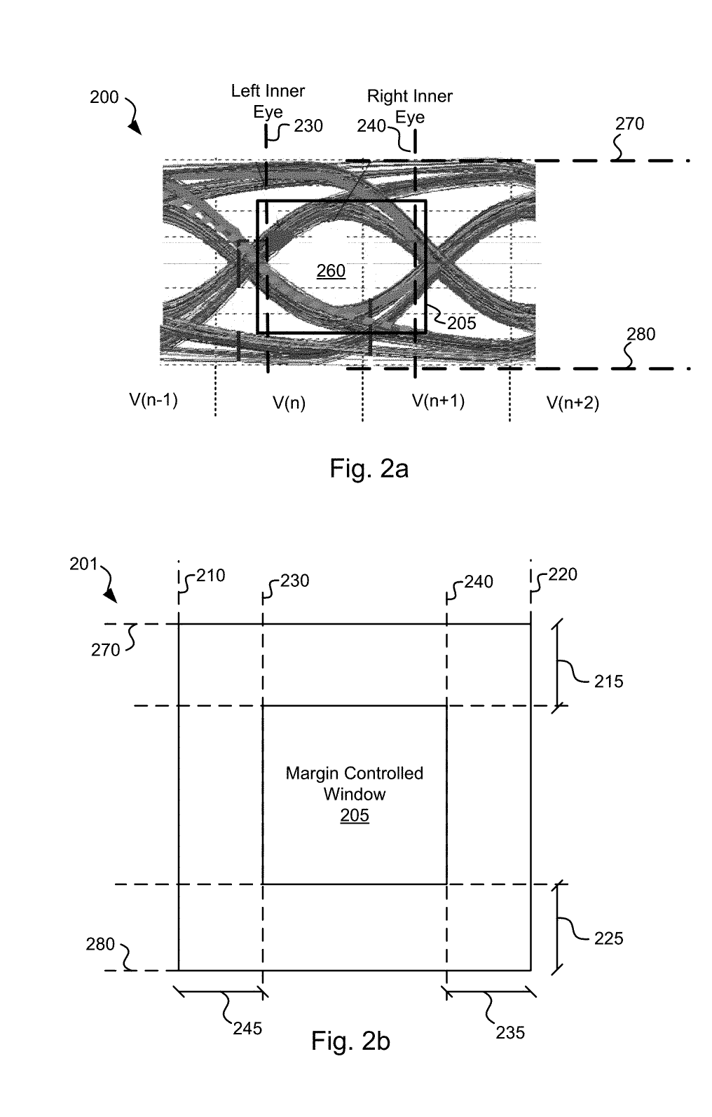

Turning to FIG. 2a, a graphical depiction 200 of an example serial data signal eye 260 bounded by a margin controlled window 205 that may be sampled using systems and/or methods in accordance with different embodiments of the present inventions. Graphical depiction 200 shows a number of symbol instances (e.g., V(n−1), V(n), V(n+1), V(n+2) separated by dotted lines) of a the serial data superimposed on upon the other. The superimposed symbol instances show a numbed of data transitions from 1->0, 0->1, 1-> and 0->0. These superimposed symbol instances define eye 260. As eye 260 is defined by the superimposition of a number of symbol instances and therefore there is some distance between an outer edges and inner edges of eye 260. In particular, a left outer edge is offset from a left inner edge 230 at the left side of eye 260; and a right outer edge is offset from a right inner edge 240 at the right side of eye 260. The sampling is done using a threshold which may varied to be centralized between an upper sample value and a lower sample value at a central sample phase between left inner edge 230 and right inner edge 240.

Turning to FIG. 2b, margin controlled window 205 is shown in relation to an overall capability window 201. In particular, capability window 201 is bounded by an upper voltage limit 270 and a lower voltage limit 280, and a left equalization limit 210 and a right equalization limit 220. Back channel equalization (i.e., calculating coefficients by serial data receiver circuit 130 and transferring the calculated coefficients back to serial data transmission circuit 110) generally takes place at discrete times during operation of serial data transfer system 100. For example, back channel adaptation may occur only at power up boot time. As it is possible for one or more device characteristics, such as, for example, temperature to change over time, the back channel equalization may not work if the back channel equalization is done using the entire capability range of the circuit(s). To assure proper operation over varying device characteristics, back channel adaptation is limited to margin controlled window 205 which is bounded by: a high voltage guard band 215 to assure under gain protection, a low voltage guard band 225 to assure over gain protection, a high equalization guard band 235 to assure under equalization protection, a low equalization guard band 245 to assure over equalization protection.

Turning to FIG. 3a, a coefficient calculation circuit 300 is shown that may be used as part of the margining enabled BCA coefficient modification circuitry of serial data receiver circuit 130 in accordance with some embodiments of the present inventions. Coefficient calculation circuit 300 calculates one coefficient, thus where two or more coefficients are to be calculated by the margining enabled BCA coefficient modification circuitry of serial data receiver circuit 130 a corresponding number of coefficient calculation circuits 300 would be implemented as part of the BCA coefficient modification circuitry of serial data receiver circuit 130. In one particular embodiment, a pre-cursor coefficient (CM1) and a post-cursor coefficient (CP1) are calculated by the BCA coefficient modification circuitry. In such an embodiment, the BCA coefficient modification circuitry of serial data receiver circuit 130 would include two instances of coefficient calculation circuit 300—one instance of coefficient calculation circuit 300 to calculate CP1 and the other instance of coefficient calculation circuit 300 to calculate CM1. Based upon the disclosure provided herein, one of ordinary skill in the art would recognize that different numbers of coefficients may be calculated by the BCA controlled equalizer circuitry of serial data transmission circuit 110 in accordance with different embodiments.

Coefficient calculation circuit 300 includes a coefficient gradient calculation circuit 305. Coefficient gradient calculation circuit 305 calculates a gradient based upon a data input 303 which is a non-return-to-zero (NRZ) decision for a received symbol generated from serial output 150, and error 301 is a least mean squared error 301 calculated for a given NRZ decision for a received symbol generated from serial output 150. In particular, coefficient gradient calculation circuit 305 calculates an accumulated gradient in accordance with the following equation:

$$Gradient = e ( A ) ⋆ sign {\sum }_{i = N}^{M} [ m ( i ) ⋆ d ( B - i ) ] ,$$

where e(A) is a selected instance of error 301, and d(B−i) are selected instances of data input 303 indexed by i, and m(i) is a mask bit used to selectively include various elements into the calculated accumulated gradient. The resulting accumulated gradient is provided as a gradient output 307 to an adder circuit 310.

In one particular embodiment: N in the above mentioned accumulated gradient equation may be programmable from a set {0, 1, 2, 3} for calculation of the pre-cursor coefficient (CM1), and from a set {3, 4, 5, 6, 7} for calculation of the post-cursor coefficient (CP1); M in the above mentioned accumulated gradient equation may be programmable from a set {0, 1, 2, 3} for calculation of the pre-cursor coefficient (CM1), and from a set {3, 4, 5, 6} for calculation of the post-cursor coefficient (CP1).

A condition determination circuit 320 identifies various conditions that cause the mask bit (m(i)) to be set equal to zero or one. In particular, condition determination circuit 320 determines: whether over equalization or excessive outer eye attenuation is possible by comparing the absolute value of the voltage level of an “XXY” transition on data input 303 (i.e., abs(DataLevelX X Y)) against a pre-defined minimum threshold value (i.e., abs(DataLevelX X Y MIN)); whether a saturated signal condition is possible by comparing the absolute value of the voltage level of the XXY transition on data input 303 against a pre-defined maximum threshold value (i.e., abs(DataLevelX X Y MAX)); or whether an overall equalization condition is possible by comparing the absolute value of the voltage level of the XXY transition on data input 303 against the absolute value of the voltage level of an “XYX” transition on data input 303 (i.e., abs (DataLevelX Y X)). As used herein, an “XXY” transition is a 1->1->0 or a 0->0->1 transition of data input 303, and an “XYX” transition is a 1->0->1 or a 0->1->0 transition of data input 303. In particular, the gradient is not updated when any of the following conditions are met:

abs(DataLevelXXY)<abs(DataLevelXXY MIN);

abs(DataLevelXXY)>abs(DataLevelXXY MAX); or

abs(DataLevelXXY)<abs(DataLevelXYX).

Where any of the preceding conditions is true, condition determination circuit 320 asserts a disable signal 322 that is provided to coefficient gradient calculation circuit 305. The mask bit (m(i)) used by coefficient gradient calculation circuit 305 is set equal to zero when disable signal 322 is asserted, and set to one when disable signal 322 is de-asserted. The pre-defined minimum threshold value and the pre-defined maximum threshold value may be any values within an overall capability window used to define a controlled eye window.

Adder circuit 310 adds an accumulated gradient 317 to gradient output 307 to yield a sum 312. Sum 312 is stored to a pre-gain accumulator circuit 315 where it is available as accumulated gradient 317. Accumulated gradient 317 may be represented by the following equation:

$$Accumulated Gradient = {\sum }_{i = 0}^{Update Rate} Gradient ,$$

where the update rate is programmable and guards against corruption by compression or other means. In one particular embodiment, the update rate is set equal to 256. Based upon the disclosure provided herein, one of ordinary skill in the art will recognize a variety of values that may programmed or fixed as the update rate.

Turning to FIG. 3b, a graphic 350 shows a window of relative instances of data input 303 and error 301 that are used to calculate the pre-cursor coefficient (CM1). As shown, when the n−3 instance of error 301 (i.e., e(n−3)) is selected, gradient 307 is calculated across the n−3, n−2, n−1, and n instances of data input 303 (i.e., d(n−3), d(n−2), d(n−1), d(n)). In such a case, gradient 307 is represented by the following equation:

$$Gradient = e ( n - 3 ) ⋆ sign {\sum }_{i = 3}^{0} [ m ( i ) ⋆ d ( n - i ) ] .$$

Based upon the disclosure provided herein, one of ordinary skill in the art will recognize that other instances of error 301 and range of data input 303 may be used to calculate a pre-cursor coefficient in accordance with different embodiments.

Turning to FIG. 3c, a graphic 370 shows a window of relative instances of data input 303 and error 301 that are used to calculate the post-cursor coefficient (CP1). As shown, when the n−3 instance of error 301 (i.e., e(n−3)) is selected, gradient 307 is calculated across the n−7, n−6, n−5, n−4, and n−3 instances of data input 303 (i.e., d(n−7), d(n−6), d(n−5), d(n−4), d(n−3)). In such a case, gradient 307 is represented by the following equation:

$$Gradient = e ( n - 3 ) ⋆ sign {\sum }_{i = 7}^{0} [ m ( i ) ⋆ d ( n - i ) ] .$$

Based upon the disclosure provided herein, one of ordinary skill in the art will recognize that other instances of error 301 and range of data input 303 may be used to calculate a post-cursor coefficient in accordance with different embodiments.

Returning to FIG. 3a, accumulated gradient 317 is provided to a gain multiplier circuit 330 where it is multiplied by a gain value 333 (i.e., BCA gain) to yield a gain adjusted accumulated gradient 332. Gain adjusted accumulated gradient 332 is provided to an adder circuit 340 where it is summed with a accumulation value 352 to yield a sum 342. Sum 342 is provided to an overflow circuit 345 that compares sum 342 against an upper limit and a lower limit. Where the upper limit is exceeded, overflow circuit 345 provides a +1 as a BCA coefficient modification output 347. In some embodiments, the upper limit is 2^{L}−1, where L is a user programmable value. Such a positive modification indicates a positive saturation to serial data transmission circuit 110. Alternatively, where the lower limit is exceeded, overflow circuit 345 provides a −1 as BCA coefficient modification output 347. In the embodiment mentioned above, the lower limit is −2^{L}, where L is the same user programmable value. Such a negative modification indicates a negative saturation to serial data transmission circuit 110. Otherwise, overflow circuit 345 provides a zero as BCA coefficient modification output 347. BCA coefficient modification output 347 (BCA Out) where neither the upper limit nor the lower limit have been exceeded may be expressed as:

BCA Out(i,n)=BCA Out(i,n−1)+Gradient(i,n)*2^{BCA Gain}.

Turning to FIG. 4, another coefficient calculation circuit 400 is shown that may be used as part of the margining enabled BCA coefficient modification circuitry of serial data receiver circuit 130 in accordance with one or more embodiments of the present inventions. Coefficient calculation circuit 400 calculates a group delay coefficient that is provided back to serial data transmission circuit 110 where it is used to assure that the opening of the eye of the transmitted data is as desired.

Coefficient calculation circuit 400 includes a group delay gradient determination circuit 405. Group delay gradient determination circuit 405 that receives data input 403 generated from serial output 150 that includes both stable state samples (d(n)) and transition samples (T(n)) occurring at transitions between stable samples. Group delay gradient determination circuit 405 selects a group delay gradient in accordance with the following pseudocode:

$$if \{ {\prod }_{i = 1}^{M} d ( n - i ) = x \} * \{ {\prod }_{i = 1}^{1} T ( n - i ) = x \} * \{ {\prod }_{i = - N}^{0} d ( n - i ) = y \}$$

$$then set group gradient delay 407 equal to + 1 ;$$

$$else if$$

$$\{ {\prod }_{i = 1}^{M} d ( n - i ) = x \} * \{ {\prod }_{i = 1}^{1} T ( n - i ) = y \} * \{ {\prod }_{i = - N}^{0} d ( n - i ) = y \}$$

$$then set group gradient delay 407 equal to + 1 ;$$

$$else$$

$$then set group gradient delay 407 equal to 0.$$

In the preceding pseudocode, y=not(x) (e.g., where x=1, y=0), and N, M define the window of samples processed. In some embodiments, M is selected from a set of {2, 3, 4, 5}, and N is zero. Thus, for a value of M equal to 2, a transition xxty is processed; for a value of M equal to 3, a transition xxxty is processed; for a value of M equal to 4, a transition xxxxty is processed; and for a value of M equal to 5, a transition xxxxxty is processed.

The resulting group delay gradient is provided as a group delay gradient output 407 to an adder circuit 410. Adder circuit 310 adds an accumulated gradient 417 to group delay gradient output 407 to yield a sum 412. Sum 412 is stored to a pre-gain accumulator circuit 415 where it is available as accumulated gradient 417. Accumulated gradient 417 may be represented by the following equation:

$$Accumulated Gradient = {\sum }_{i = 0}^{Update Rate} Gradient ,$$

where the update rate is programmable and guards against corruption by compression or other means. In one particular embodiment, the update rate is set equal to 256. Based upon the disclosure provided herein, one of ordinary skill in the art will recognize a variety of values that may programmed or fixed as the update rate.

Accumulated gradient 417 is provided to a gain multiplier circuit 430 where it is multiplied by a gain value 433 (i.e., BCA gain) to yield a gain adjusted accumulated gradient 432. Gain adjusted accumulated gradient 432 is provided to an adder circuit 440 where it is summed with a accumulation value 452 to yield a sum 442. Sum 442 is provided to an overflow circuit 445 that compares sum 442 against an upper limit and a lower limit. Where the upper limit is exceeded, overflow circuit 445 provides a +1 as a BCA coefficient modification output 447. In some embodiments, the upper limit is 2^{L}−1, where L is a user programmable value. Such a positive modification indicates a positive saturation to serial data transmission circuit 110. Alternatively, where the lower limit is exceeded, overflow circuit 445 provides a −1 as BCA coefficient modification output 447. In the embodiment mentioned above, the lower limit is −2^{L}, where L is the same user programmable value. Such a negative modification indicates a negative saturation to serial data transmission circuit 110. Otherwise, overflow circuit 445 provides a zero as BCA coefficient modification output 447. BCA coefficient modification output 447 (BCA Out) where neither the upper limit nor the lower limit have been exceeded may be expressed as:

BCA Out(i,n)=BCA Out(i,n−1)+Gradient(i,n)*2^{BCA Gain}.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent, albeit such a system would not be a circuit. In other cases, the one part of a given system, block or circuit may be implemented in software or firmware, while other parts are implemented in hardware.

In conclusion, the inventions provide novel systems, devices, methods and arrangements for data processing. While detailed descriptions of one or more embodiments of the inventions have been given above, various alternatives, modifications, and equivalents will be apparent to those skilled in the art without varying from the spirit of the inventions. Therefore, the above description should not be taken as limiting the scope of the inventions, which is defined by the appended claims.

What is claimed is:

1. A serial data processing system, the system comprising:
a data receiving circuit including a coefficient calculation circuit, wherein the data receiving circuit is operable to receive a serial data input, and wherein the coefficient calculation circuit is operable to:
calculate a gradient output based at least in part upon a first instance of the serial data input, a second instance of the serial data input, and a third instance of the serial data input;
determine a first disable condition for the first instance of the serial data input, a second disable condition for the second instance of the serial data input, and a third disable condition for the third instance of the serial data input; and
include the first instance of the serial data input in the calculation of the gradient output based upon the first disable condition, and include the second instance of the serial data input in the calculation of the gradient output based upon the second disable condition, and exclude the third instance of the serial data input in the calculation of the gradient output based upon the third disable condition.

2. The serial data processing system of claim 1, wherein the third disable condition is selected from a group consisting of: an absolute value of a voltage level of an XXY transition corresponding to the third instance of the serial data input being less than an absolute value of a voltage level of an XYX transition, an absolute value of the voltage level of the XXY transition corresponding to the third instance of the serial data input being less than a first threshold, and an absolute value of the voltage level of the XXY transition corresponding to the third instance of the serial data input being greater than a second threshold.

3. The serial data processing system of claim 1, the system further comprising:
a first accumulator circuit operable to add the gradient output to previous instance of an accumulated gradient output to yield a subsequent instance of the accumulated gradient output; and
a second accumulator circuit operable to add an accumulator input derived from the subsequent instance of the accumulated gradient output to a previous instance of a sum to yield a subsequent instance of the sum.

4. The serial data processing system of claim 3, the system further comprising:
a comparator circuit operable to compare the subsequent instance of the sum with an upper limit and a lower limit to yield a coefficient modification output, wherein the coefficient modification output is set equal to: a first value when the subsequent instance of the sum is greater than the upper threshold, a second value when the subsequent instance of the sum is between the upper threshold and the lower threshold, or a third value when the subsequent instance of the sum is less than the lower threshold.

5. The serial data processing system of claim 4, wherein at least one of the upper threshold or the lower threshold is programmable.

6. The serial data processing system of claim 3, the system further comprising:
a multiplication circuit operable to multiply the subsequent instance of the accumulated gradient output by a gain to yield the accumulator input.

7. The serial data processing system of claim 6, wherein the gain is programmable.

8. The serial data processing system of claim 1, the system further comprising:
a serial data transmission circuit including a filter circuit, wherein the filter circuit is operable to apply a filtering algorithm to a transfer data set to yield an output data set, wherein the serial data input is derived from the output data set, wherein operation of the filter circuit is governed at least in part based upon a coefficient modification output received from the data receiving circuit, and wherein the coefficient modification output corresponds to the gradient output.

9. The serial data processing system of claim 1, wherein the data receiving circuit is implemented as part of an integrated circuit.

10. The serial data processing system of claim 1, wherein the serial data processing system is implemented as part of a storage device.

11. A serial data processing system, the system comprising:
a data receiving circuit including a coefficient determination circuit, wherein the data receiving circuit is operable to receive a serial data input, and wherein the coefficient determination circuit is operable to:
set a gradient output equal to a first value when a series of a preceding number of instances of the serial data input are equal to an x value, an instance of the serial data corresponding to a transition between the x value and a y value is equal to the x value, and a series of a succeeding number of instances of the serial data input are equal to the y value, wherein the x value is a first binary state and the y value is a second binary state opposite the first binary state;
set the gradient output equal to a second value when the series of the preceding number of instances of the serial data input are equal to the x value, the instance of the serial data corresponding to the transition between the x value and the y value is equal to the y value, and the series of the succeeding number of instances of the serial data input are equal to the y value.

12. The serial data processing system of claim 11, the system further comprising:
a first accumulator circuit operable to add the gradient output to previous instance of an accumulated gradient output to yield a subsequent instance of the accumulated gradient output; and
a second accumulator circuit operable to add an accumulator input derived from the subsequent instance of the accumulated gradient output to a previous instance of a sum to yield a subsequent instance of the sum.

13. The serial data processing system of claim 12, the system further comprising:
a comparator circuit operable to compare the subsequent instance of the sum with an upper limit and a lower limit to yield a coefficient modification output, wherein the coefficient modification output is set equal to: a first value when the subsequent instance of the sum is greater than the upper threshold, a second value when the subsequent instance of the sum is between the upper threshold and the lower threshold, or a third value when the subsequent instance of the sum is less than the lower threshold.

14. The serial data processing system of claim 13, wherein at least one of the upper threshold or the lower threshold is programmable.

15. The serial data processing system of claim 12, the system further comprising:
a multiplication circuit operable to multiply the subsequent instance of the accumulated gradient output by a gain to yield the accumulator input.

16. The serial data processing system of claim 15, wherein the gain is programmable.

17. The serial data processing system of claim 11, the system further comprising:
a serial data transmission circuit including a filter circuit, wherein the filter circuit is operable to apply a filtering algorithm to a transfer data set to yield an output data set, wherein the serial data input is derived from the output data set, wherein operation of the filter circuit is governed at least in part based upon a coefficient modification output received from the data receiving circuit, and wherein the coefficient modification output corresponds to the gradient output.

18. The serial data processing system of claim 11, wherein the data receiving circuit is implemented as part of an integrated circuit.

19. The serial data processing system of claim 11, wherein the serial data processing system is implemented as part of a storage device.

20. A method for serial data processing, the method comprising:
receiving a serial data input at a serial data receiver circuit, wherein the serial data input is received from a serial data transmission circuit;
calculating a gradient output based at least in part upon a first instance of the serial data input, a second instance of the serial data input, and a third instance of the serial data input;
determining a first disable condition for the first instance of the serial data input, a second disable condition for the second instance of the serial data input, and a third disable condition for the third instance of the serial data input;
including the first instance of the serial data input in the calculation of the gradient output based upon the first disable condition;
including the second instance of the serial data input in the calculation of the gradient output based upon the second disable condition;
excluding the third instance of the serial data input in the calculation of the gradient output based upon the third disable condition, wherein the third disable condition is selected from a group consisting of: an absolute value of a voltage level of an XXY transition corresponding to the third instance of the serial data input being less than an absolute value of a voltage level of an XYX transition, an absolute value of the voltage level of the XXY transition corresponding to the third instance of the serial data input being less than a first threshold, and an absolute value of the voltage level of the XXY transition corresponding to the third instance of the serial data input being greater than a second threshold;
generating a coefficient modification value corresponding to the gradient output;
transferring the coefficient modification value to the serial data transmission circuit via a medium; and
generating the serial data input in the serial data transmission circuit using the coefficient modification value.
